(19) United States
(12) Patent Application Publication
(10) Pub. No.: US 2025/0138873 A1
(43) Pub. Date: May 1, 2025

(54) CONTAINER SCHEDULER FOR BALANCED COMPUTING RESOURCE USAGE

(71) Applicant: INTERNATIONAL BUSINESS MACHINES CORPORATION, ARMONK, NY (US)

(72) Inventors: Paritosh RANJAN, Kolkata (IN); Prodip ROY, Kolkata (IN); Prosanta SAHA, Kolkata (IN); Bhubaneswar PADHAN, Kolkata (IN)

(21) Appl. No.: 18/384,070

(22) Filed: Oct. 26, 2023

(51) Int. Cl. G06F 9/48; G06F 9/50

(52) U.S. Cl. CPC G06F 9/4881; G06F 9/5083

(57) ABSTRACT

An approach is provided for scheduling containers on multiple nodes of a cluster so that percentages of a computing resource being utilized on the multiple nodes are modified to match each other within a specified threshold amount. Differences are determined in percentages of the computing resource being used between nodes included in pairs of nodes included in the multiple nodes. It is determined that a difference of percentages of the computing resource being used between a first node and a second node exceeds the specified threshold amount. The first and second nodes are included in a given pair of nodes included in the pairs of nodes. One or more containers are shuffled between the first and second nodes so that a difference of percentages of the computing resource being used between the first and second nodes does not exceed the specified threshold amount.

### BACKGROUND

The present invention relates to container orchestration, and more particularly to container scheduling on multiple nodes of a cluster.

Containers and Kubernetes® clusters are being used in public and private cloud computing environments. Several container orchestration engines (e.g., Kubernetes®, OpenShift®, and Mesos® container orchestration engines) are available in the various cloud computing environments. A container is a software package that includes all the necessary elements (e.g., code and related configuration files, libraries, and dependencies) for an application to run in any computing environment. A container orchestration engine is a software engine that automatically deploys, manages, scales, and networks containers.

Kubernetes is a registered trademark of The Linux Foundation located in San Francisco, California. OpenShift is a registered trademark of Red Hat, Inc. located in Raleigh, North Carolina. Mesos is a registered trademark of The Apache Software Foundation located in Wilmington, Delaware.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include scheduling containers on multiple nodes of a cluster so that percentages of a computing resource being utilized on the multiple nodes are modified to match each other within a specified threshold amount. The scheduling includes determining differences of percentages of the computing resource being used between nodes included in pairs of nodes included in the multiple nodes. The scheduling further includes determining that a difference of percentages of the computing resource being used between a first node and a second node exceeds the specified threshold amount. The first and second nodes are included in a given pair of nodes included in the pairs of nodes. The scheduling further includes shuffling one or more containers between the first and second nodes so that a difference of percentages of the computing resource being used between the first and second nodes does not exceed the specified threshold amount.

A computer program product and a method corresponding to the above-summarized computer system are also described herein.

### BRIEF DESCRIPTION OF THE DRAWINGS

FIG. 1 is a block diagram of a system for scheduling containers on multiple nodes of a cluster for balancing computing resource consumption among the nodes within a specified threshold amount, in accordance with embodiments of the present invention.

FIG. 2 is a block diagram of modules included in code included in the system of FIG. 1, in accordance with embodiments of the present invention.

FIG. 3 is a flowchart of a process of scheduling containers on multiple nodes of a cluster for balancing computing resource consumption among the nodes within a specified threshold amount, where operations of the flowchart are performed by the modules in FIG. 2, in accordance with embodiments of the present invention.

FIG. 4 is a flowchart of a process of shuffling containers of N_{mhigh} and N_{nlow} nodes in a pair of nodes in the process of FIG. 3, so that the computing resource consumption on the nodes in the pair becomes balanced between the nodes within a specified threshold amount.

### DETAILED DESCRIPTION

### Overview

Known container scheduling mechanisms schedule containers on different nodes of a cluster by using scheduling algorithms. Existing scheduling algorithms schedule containers on nodes in such a way that a measurement of one computational factor on some of the nodes becomes extremely high, while at the same time a measurement of the same computation factor on other nodes is extremely low. As used herein, a computational factor is defined as a usage of a computing resource and includes, for example, memory usage, central processing unit (CPU) usage, network usage, or disk usage. The aforementioned condition of extremely high measurements of a computational factor on some nodes and extremely low measurements of the computational factor on other nodes creates problems, such as memory exhaustion in certain nodes, which results in various issues, including frequent restarts of containers, inability to spawn containers on a node, and frequent movements of containers between nodes. The aforementioned problems lead to application instability, downtime, and overall degraded performance, in spite of a given computational factor being available on several other nodes of the clusters, but remaining unutilized due to the conventional container scheduler's inability to utilize the computational factor on the other nodes.

Embodiments of the present invention address the aforementioned unique challenges by providing a container scheduling mechanism which schedules containers on nodes of a cluster, so that percentages of memory (or another computing resource) consumed on respective nodes of the cluster are equal or close to being equal (i.e., the aforementioned percentages are balanced within a specified threshold amount). As used herein, percentages close to being equal means that the difference between the percentages is less than or equal to a specified threshold amount.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

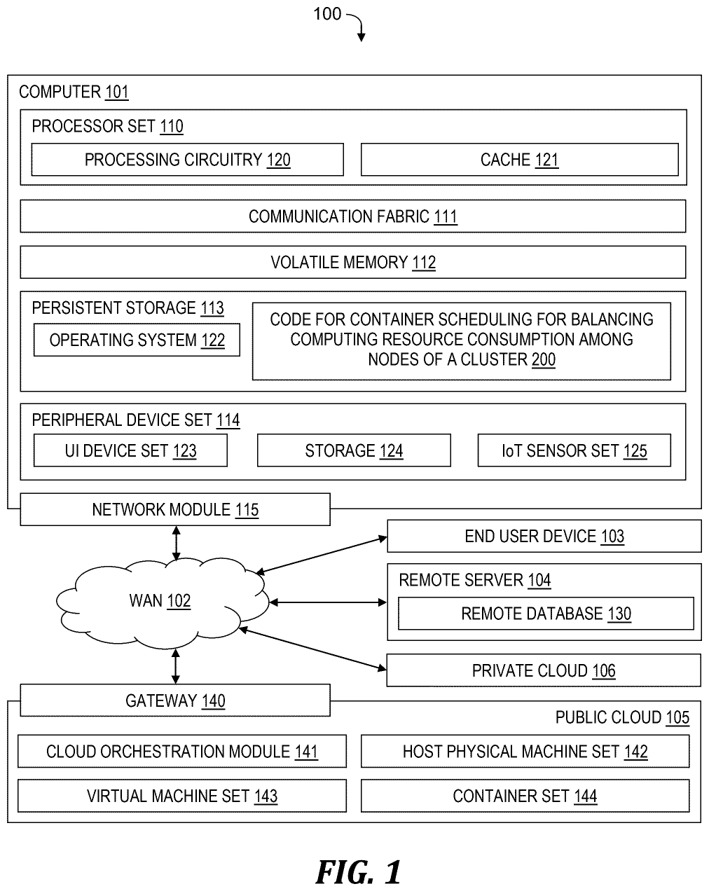

FIG. 1 is a block diagram of a system for scheduling containers on multiple nodes of a cluster for balancing computing resource consumption among the nodes within a specified threshold amount, in accordance with embodiments of the present invention. Computing environment 100 contains an example of an environment for the execution of at least some of the computer code involved in performing the inventive methods, such as code 200 for container scheduling for balancing computing resource consumption among nodes of a cluster within a specified threshold amount. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Container Scheduling for Balancing Computing Resource Consumption

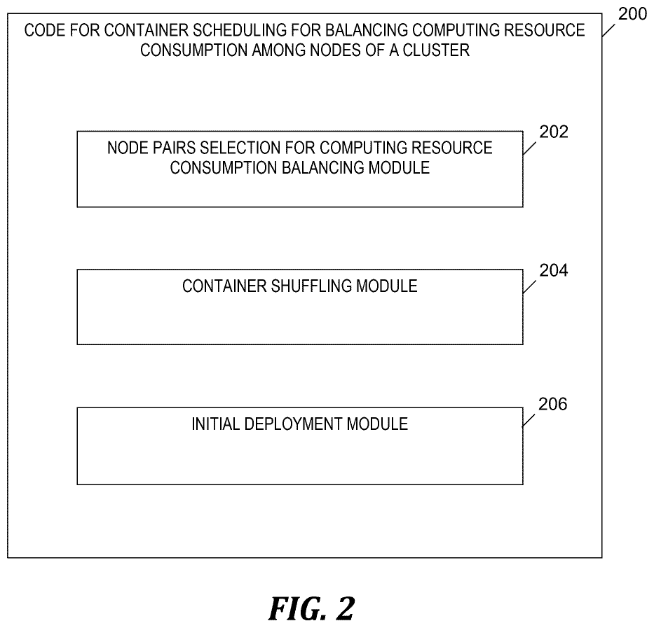

FIG. 2 is a block diagram of modules included in code included in the system of FIG. 1, in accordance with embodiments of the present invention. Code 200 includes a node pairs selection for computing resource consumption balancing module 202, a container shuffling module 204, and an initial deployment module 206. Node pairs selection for computing resource consumption balancing module 202 is configured to select node pairs based on computing resource consumption (i.e., usage) differences between nodes in the node pairs being greater than a specified threshold amount. In one embodiment, an enhanced container scheduler performs the aforementioned node pair selection and is executed by processor set 110 included in computer 101.

Container shuffling module 204 is configured to shuffle containers of nodes included in a node pair selected by node pairs selection for computing resource consumption balancing module 202. The shuffling of the containers includes calculating the actual consumption values of the computing resource for each of the nodes in the node pair and calculating the actual computing resource difference (i.e., the modulus of the difference between the actual consumption values for the nodes in the node pair). The shuffling of the containers further includes iterating over an ordered list of containers of the node (i.e., N_{mhigh} node) in the node pair that has the greater computer resource consumption as compared to the other node (i.e., N_{nlow} node) in the node pair. The list of containers is ordered according to the computing resource usages of the respective containers. The iteration over the ordered list includes moving a given container from the N_{mhigh} node to the N_{nlow} node if the computing resource consumption value for the given container is less than the actual computing resource difference, which is described above.

After the iteration over the ordered list, the shuffling includes recalculating the actual computing resource difference between the N_{mhigh} and N_{nlow} nodes. The recalculated actual computing resource difference indicates that the iteration over the ordered list provides the N_{mhigh} and N_{nlow} nodes with computing resource consumption values that are balanced (e.g., similar or almost equal) within a specified threshold amount.

Initial deployment module 206 is configured to initially deploy the containers on empty nodes of the cluster using historical information about the computing resource usage of the containers. The initial deployment module 206 designates a computing resource usage provided by the historical information for a given container as the initial computing resource consumption value for the given container. These designated initial computing resource consumption values for the containers can be used in the container scheduling algorithm provided by node pairs selection for computing resource consumption balancing module 202 and container shuffling module 204.

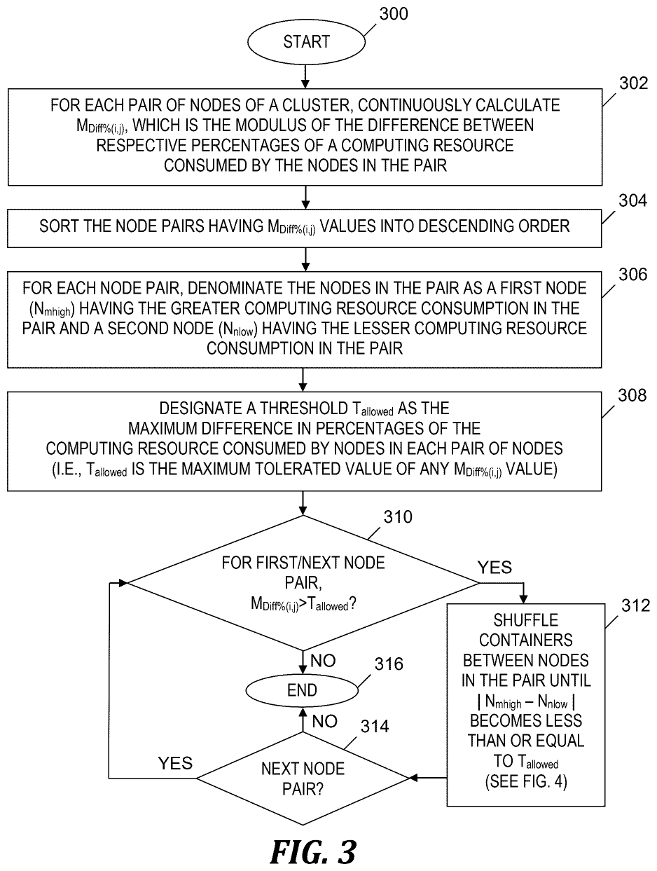

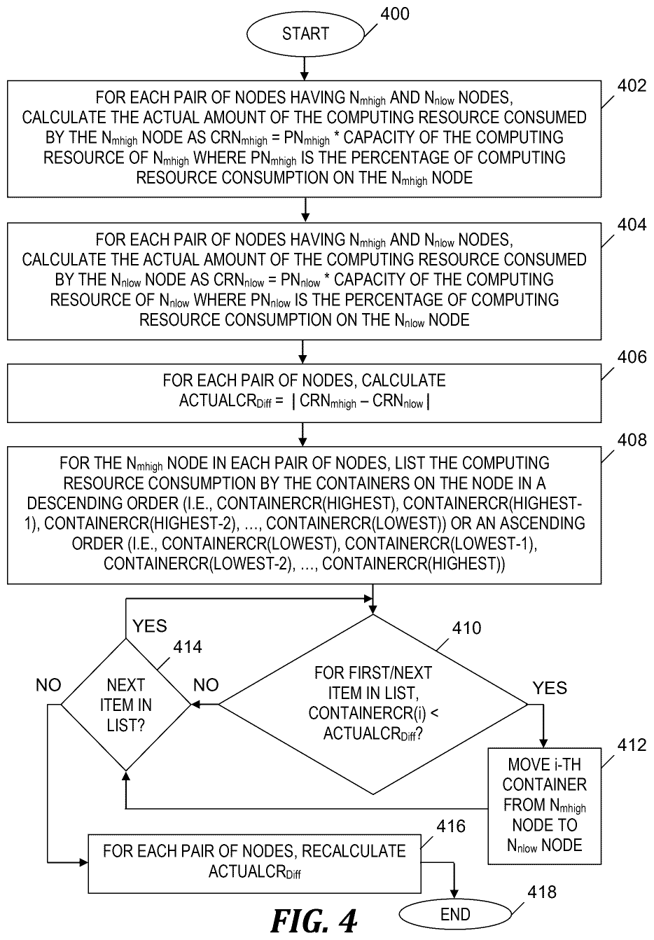

The functionality of the modules included in code 200 is described in more detail in the discussions presented below relative to FIG. 3 and FIG. 4.

FIG. 3 is a flowchart of a process of scheduling containers on multiple nodes of a cluster for balancing computing resource consumption among the nodes within a specified threshold amount, where operations of the flowchart are performed by the modules in FIG. 2, in accordance with embodiments of the present invention. The process of FIG. 3 begins at a start node 300. In step 302, for each pair of nodes of a cluster that includes n worker nodes N₁, N₂, . . . , Nₙ, node pairs selection for computing resource consumption balancing module 202 continuously calculates:

M_{Diff %(i,j)}=modulus of the difference between respective percentages of a computing resource consumed by the nodes in the (i,j)-th pair of nodes of the cluster.

For example, if the computing resource is memory, step 302 includes the calculations:

$${M}_{Diff \% ( 1 , 2 )} = \vert \% memory usage of node {N}_{1} - \% memory usage of node {N}_{2} \vert \\ … \\ {M}_{Diff \% ( 1 , n )} = \vert \% memory usage of node {N}_{1} - \% memory usage of node {N}_{n} \vert \\ … \\ {M}_{Diff \% ( n - 1 , n )} = \vert \% memory usage of node {N}_{n - 1} - \% memory usage of node {N}_{n} \vert$$

In step 304, node pairs selection for computing resource consumption balancing module 202 sorts the node pairs having M_{Diff %(i,j)} values calculated in step 302 into descending order according to the M_{Diff %(i,j)} values.

In step 306, for each node pair, node pairs selection for computing resource consumption balancing module 202 denominates the nodes in the node pair as a first node (N_{mhigh}) and a second node (N_{nlow}), where the computing resource consumption of N_{mhigh} (i.e., the percentage of the computing resource used by node N_{mhigh}) is greater than or equal to the computing resource consumption of N_{nlow} (i.e., the percentage of the computing resource used by node N_{nlow}). For example, if the computing resource is memory, then the percentage of memory consumption of N_{mhigh} is greater than or equal to the percentage of memory consumption of N_{nlow}.

In step 308, node pairs selection for computing resource consumption balancing module 202 designates a threshold T_{allowed} as the maximum difference that is tolerated in percentages of the computing resource consumed by nodes in each pair of nodes of the cluster. That is, T_{allowed} is the maximum tolerated value for any of the M_{Diff %(i,j)} values calculated in step 302.

In step 310, for a first node pair (i,j) or a next node pair (i,j) in the node pairs sorted in descending order in step 304, container shuffling module 204 determines whether M_{Diff %(i,j)}>T_{allowed}. If container shuffling module 204 determines in step 310 that M_{Diff %(i,j)}>T_{allowed}, then the Yes branch of step 310 is followed and step 312 is performed. For the first time step 310 is performed in the process of FIG. 3, the first node pair in the node pairs sorted in step 304 is processed in step 310 (i.e., the node pair having the greatest M_{Diff %(i,j)} value among the node pairs in the cluster is the first node pair in the sorted node pairs). For any subsequent performance of step 310 in the process of FIG. 3, a next node pair is selected from the node pairs sorted in step 304 and the next node pair is processed in step 310. For example, for the second time step 310 is performed in the process of FIG. 3, the node pair having the second greatest M_{Diff %(i,j)} value is selected and processed in step 310.

In step 312, container shuffling module 204 shuffles containers between the nodes in the node pair (i.e., the node pair that was processed in the most recent performance of step 310), until |N_{mhigh}−N_{nlow}| becomes less than or equal to T_{allowed}. The shuffling of containers in step 312 is further described below relative to FIG. 4.

In step 314, container shuffling module 204 determines if there is a next node pair in the node pairs that were sorted in descending order according to M_{Diff %(i,j)} values in step 304, where the next node pair has not yet been processed in step 310. If container shuffling module 204 determines in step 314 that there is a next node pair that has not yet been processed in step 310, then the Yes branch of step 314 is followed and the process loops back to step 310, as described above.

If container shuffling module 204 determines in step 314 that there is no next node pair that has not yet been processed in step 310 (i.e., all the node pairs in the sorted node pairs have been processed in step 310), then the No branch of step 314 is followed and the process of FIG. 3 ends at an end node 316.

Returning to step 310, if container shuffling module 204 determines that M_{Diff %(i,j)} is not greater than T_{allowed}, then the No branch of step 310 is followed and the process of FIG. 3 ends at the end node 316.

FIG. 4 is a flowchart of a process of shuffling containers of N_{mhigh} and N_{nlow} nodes in a pair of nodes in the process of FIG. 3, so that the computing resource consumption on the nodes in the pair becomes balanced between the nodes within a specified threshold amount. The process of FIG. 4 starts at a start node 400. In step 402, for each pair of nodes having N_{mhigh} and N_{nlow} nodes, container shuffling module 204 calculates the actual amount of the computing resource consumed by the N_{mhigh} node using the following calculation:

CRN_{mhigh}=PN_{mhigh}*capacity of the computing resource of N_{mhigh},
where PN_{mhigh} is the percentage of the computing resource consumed on the N_{mhigh} node.

In step 404, for each pair of nodes having N_{mhigh} and N_{nlow} nodes, container shuffling module 204 calculates the actual amount of the computing resource consumed by the N_{nlow} node using the following calculation:

CRN_{nlow}=PN_{nlow}*capacity of the computing resource of N_{nlow},
where PN_{nlow} is the percentage of the computing resource consumed on the N_{nlow} node.

In step 406, for each pair of nodes, container shuffling module 204 calculates an actual computing resource consumption difference using the following calculation:

ActualCR_{Diff}=|CRN_{mhigh}−CRN_{nlow}|

In step 408, for the N_{mhigh} node in each pair of nodes, container shuffling module 204 generates a list of actual consumptions of the computing resource by respective containers on the node in (i) a descending order (i.e., ContainerCR(Highest), ContainerCR(Highest−1), ContainerCR(Highest−2), . . . , ContainerCR(Lowest)) or (ii) an ascending order (i.e., ContainerCR(Lowest), ContainerCR(Lowest−1), ContainerCR(Lowest−2), . . . , ContainerCR(Highest)).

In step 410, for the first or next item (i.e., the i-th item) in the list generated in step 408, container shuffling module 204 determines whether ContainerCR(i)<ActualCR_{Diff}. If container shuffling module 204 determines in step 410 that ContainerCR(i)<ActualCR_{Diff}, then the Yes branch of step 410 is followed and step 412 is performed.

For the first time step 410 is performed in the process of FIG. 4, the first item in the list generated in step 408 is processed in step 410 (i.e., the computing resource consumption of the container having the greatest actual computing resource consumption if the list is in descending order, or the computing resource consumption of the container having the least actual computing resource consumption if the list is in ascending order). For any subsequent performance of step 410 in the process of FIG. 4, a next computing resource consumption value of the next container is selected from the list generated in step 408 and the next computing resource consumption value is processed in step 410. For example, for the second time step 410 is performed in the process of FIG. 4, where the list generated in step 408 is in descending order, the second greatest computing resource consumption value is selected and processed in step 410.

In step 412, container shuffling module 204 moves the i-th container from the N_{mhigh} node to the N_{nlow} node.

In step 414, container shuffling module 204 determines whether there is a next item in the list generated in step 408 that has not yet been processed in step 410. If container shuffling module 204 determines in step 414 that there is a next item in the list generated in step 408, then the Yes branch of step 414 is followed and the process of FIG. 4 loops back to step 410, as described above, using the next computer resource consumption value from the list.

If container shuffling module 204 determines in step 414 that there is no next item in the list remaining to be processed (i.e., all the items in the list generated in step 408 have already been processed in multiple performances of step 410), then the No branch of step 414 is followed and step 416 is performed.

In step 416, for each pair of nodes, container shuffling module 204 recalculates the ActualCR_{Diff} value, using recalculations of CRN_{mhigh} and CRN_{nlow}. Following step 416, the process of FIG. 4 ends at an end node 418.

Returning to step 410, if container shuffling module 204 determines that ContainerCR(i) is not less than ActualCR_{Diff}, then the No branch of step 410 is followed and the process of FIG. 4 continues with step 414, as described above.

In one embodiment, for each node pair, container shuffling module 204 iterates over the list generated in step 408 from ContainerCR(Lowest) to ContainerCR(Highest) if the list is in ascending order, or from ContainerCR(Highest) to ContainerCR(Lowest) if the list is in descending order, and uses steps 410, 412, 414, and 416 in the iteration. After the iteration is complete, both the nodes N_{mhigh} and N_{nlow} have computing resource usage that is almost equal (i.e., have computing resource usages that vary by no more than the specified threshold amount).

In one embodiment, prior to the processes of FIG. 3 and FIG. 4, initial deployment module 206 initially deploys the containers on empty nodes of the cluster using historical information about the computing resource usage of the containers. Initial deployment module 206 designates a computing resource usage provided by the historical information for a given container as the initial computing resource consumption value for the given container. During the processes of FIG. 3 and FIG. 4, code 200 uses these designated initial computing resource consumption values for the containers for making the decisions on whether to move a container from the N_{mhigh} node to the N_{nlow} node.

As one example relative to FIG. 4, if the computing resource is memory, then PN_{mhigh} is the percentage of memory usage on the N_{mhigh} node, PN_{nlow} is the percentage of memory usage on the N_{nlow} node, MemoryN_{mhigh} is the actual memory consumed by the N_{mhigh} node, and MemoryN_{nlow} is the actual memory consumed by the N_{nlow} node, then step 404 calculates:

MemoryN_{mhigh}=PN_{mhigh}*memory capacity of the N_{mhigh} node

MemoryN_{nlow}=PN_{nlow}*memory capacity of the N_{nlow} node

Continuing the same example, step 406 calculates the actual memory difference between the N_{mhigh} and N_{nlow} nodes as:

ActualMemory_{Diff}=|MemoryN_{mhigh}−MemoryN_{nlow}|

Continuing this example, step 408 includes listing the memory usages of containers on the N_{mhigh} node as a list in (i) the descending order of ContainerMemory(Highest), ContainerMemory(Highest−1), ContainerMemory(Highest−2), . . . , ContainerMemory(Lowest) or (ii) the ascending order of ContainerMemory(Lowest), ContainerMemory(Lowest−1), ContainerMemory(Lowest−2), . . . , ContainerMemory(Highest).

For each node pair in this example, container shuffling module 204 iterates over the list of containers of N_{mhigh} from ContainerMemory(lowest) to ContainerMemory(Highest) or ContainerMemory(Highest) to ContainerMemory(Lowest) and moves the container from the N_{mhigh} node to the N_{nlow} node if ContainerMemory(i)<ActualMemory_{Diff}. For instance, if ContainerMemory(Highest) is less than ActualMemory_{Diff}, then container shuffling module 204 moves ContainerMemory(Highest) from the N_{mhigh} node to the N_{nlow} node.

Continuing this example, in step 416, container shuffling module 204 recalculates the memory difference ActualMemory_{Diff} between the N_{mhigh} and N_{nlow} nodes for each pair of nodes and the iteration over the list generated in step 408 is completed. After the completion of the iteration, both the nodes N_{mhigh} and N_{nlow} have almost equal memory usage (i.e., have a difference in memory usage values that does not exceed the specified threshold amount).

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
scheduling containers on multiple nodes of a cluster so that percentages of a computing resource being utilized on the multiple nodes are modified to match each other within a specified threshold amount, wherein the scheduling includes:
determining differences of percentages of the computing resource being used between nodes included in pairs of nodes included in the multiple nodes;
determining that a difference of percentages of the computing resource being used between a first node and a second node exceeds the specified threshold amount, the first and second nodes are included in a given pair of nodes included in the pairs of nodes; and
shuffling one or more containers between the first and second nodes so that a difference of percentages of the computing resource being used between the first and second nodes does not exceed the specified threshold amount.

2. The computer system of claim 1, wherein the computer readable code including the data and the instructions causes the one or more computer processors to perform the following further operation:
repeating the shuffling for one or more containers between other first and second nodes in any other of the pairs of nodes in which a difference of percentages of the computing resource being used between the other first and second nodes exceeds the specified threshold amount, wherein the repeating provides a scheduling of the containers so that respective percentages of the computing resource consumed on the multiple nodes are within the specified threshold amount.

3. The computer system of claim 1, wherein the computer readable code including the data and the instructions causes the one or more computer processors to perform the following further operations:
determining that the first node in the given pair of nodes has greater consumption of the computing resource than the second node in the given pair of nodes;
based on the first node in the given pair of nodes having the greater consumption of the computing resource than the second node in the given pair of nodes, identifying containers on the first node in the given pair of nodes, determining respective usages of the computing resource for the identified containers, and generating an ordered list of the identified containers with the identified containers being ordered according to the respective usages;
determining a first actual amount of the computing resource consumed by the first node in the given pair of nodes;
determining a second actual amount of the computing resource consumed by the second node in the given pair of nodes;
calculating an actual computing resource difference as a difference between the first and second actual amounts of the computing resource consumed on the first and second nodes, respectively, in the given pair of nodes;
performing an iteration over the ordered list for the given pair of nodes and for a given identified container in the iteration,
determining that a usage of the computing resource for the given identified containers is less than the actual computing resource difference; and
based on the usage of the computing resource for the given identified container being less than the actual computing resource difference, moving the given identified container from the first node in the given pair of nodes to the second node in the given pair of nodes; and
recalculating the actual computing resource difference based on the first and second actual amounts of the computing resource consumed on the first and second nodes, respectively, being updated as a result of the moving the given identified container from the first node to the second node.

4. The computer system of claim 3, wherein the recalculated actual computing resource difference does not exceed the specified threshold amount subsequent to the iteration.

5. The computer system of claim 1, wherein the computer readable code including the data and the instructions causes the one or more computer processors to perform the following further operations:
obtaining historical information about usage of the computing resource by the containers; and
initially deploying the containers on empty nodes based on the historical information, with a usage of the computing resource for a container on a node being initially assigned a value from the historical information.

6. The computer system of claim 1, wherein the computer readable code including the data and the instructions causes the one or more computer processors to perform the following further operations:
continuously calculating modulus values by calculating a modulus of a difference between percentages of usage of the computing resource for each pair of nodes in the multiple nodes;
sorting the modulus values in descending order; and
denominating nodes of each pair of nodes as N_{mhigh} and N_{nlow}, so that a consumption of the computing resource for N_{mhigh} is greater than a consumption of the computing resource for N_{nlow},
wherein the shuffling the one or more containers between the first and second nodes includes shuffling containers of N_{mhigh} and N_{nlow}, so that a modulus of a difference between a first percentage of the computing resource being consumed by N_{mhigh} and a second percentage of the computing resource being consumed by N_{nlow} is less than the specified threshold amount.

7. The computer system of claim 1, wherein the computing resource being utilized includes a memory, a central processing unit, a disk, or a computer network resource.

8. A computer program product comprising:
one or more computer readable storage media having computer readable program code collectively stored on the one or more computer readable storage media, the computer readable program code being executed by one or more processors of a computer system to cause the computer system to perform at least the following operations:
scheduling containers on multiple nodes of a cluster so that percentages of a computing resource being utilized on the multiple nodes are modified to match each other within a specified threshold amount, wherein the scheduling includes:
determining differences of percentages of the computing resource being used between nodes included in pairs of nodes included in the multiple nodes;
determining that a difference of percentages of the computing resource being used between a first node and a second node exceeds the specified threshold amount, the first and second nodes are included in a given pair of nodes included in the pairs of nodes; and
shuffling one or more containers between the first and second nodes so that a difference of percentages of the computing resource being used between the first and second nodes does not exceed the specified threshold amount.

9. The computer program product of claim 8, wherein the computer readable program code being executed by the one or more processors of the computer system causes the computer system to perform the following further operation:
repeating the shuffling for one or more containers between other first and second nodes in any other of the pairs of nodes in which a difference of percentages of the computing resource being used between the other first and second nodes exceeds the specified threshold amount, wherein the repeating provides a scheduling of the containers so that respective percentages of the computing resource consumed on the multiple nodes are within the specified threshold amount.

10. The computer program product of claim 8, wherein the computer readable program code being executed by the one or more processors of the computer system causes the computer system to perform the following further operations:
determining that the first node in the given pair of nodes has greater consumption of the computing resource than the second node in the given pair of nodes;
based on the first node in the given pair of nodes having the greater consumption of the computing resource than the second node in the given pair of nodes, identifying containers on the first node in the given pair of nodes, determining respective usages of the computing resource for the identified containers, and generating an ordered list of the identified containers with the identified containers being ordered according to the respective usages;
determining a first actual amount of the computing resource consumed by the first node in the given pair of nodes;
determining a second actual amount of the computing resource consumed by the second node in the given pair of nodes;
calculating an actual computing resource difference as a difference between the first and second actual amounts of the computing resource consumed on the first and second nodes, respectively, in the given pair of nodes;
performing an iteration over the ordered list for the given pair of nodes and for a given identified container in the iteration,
determining that a usage of the computing resource for the given identified containers is less than the actual computing resource difference; and
based on the usage of the computing resource for the given identified container being less than the actual computing resource difference, moving the given identified container from the first node in the given pair of nodes to the second node in the given pair of nodes; and
recalculating the actual computing resource difference based on the first and second actual amounts of the computing resource consumed on the first and second nodes, respectively, being updated as a result of the moving the given identified container from the first node to the second node.

11. The computer program product of claim 10, wherein the recalculated actual computing resource difference does not exceed the specified threshold amount subsequent to the iteration.

12. The computer program product of claim 8, wherein the computer readable program code being executed by the one or more processors of the computer system causes the computer system to perform the following further operations:
obtaining historical information about usage of the computing resource by the containers; and
initially deploying the containers on empty nodes based on the historical information, with a usage of the computing resource for a container on a node being initially assigned a value from the historical information.

13. The computer program product of claim 8, wherein the computer readable code including the data and the instructions causes the one or more computer processors to perform the following further operations:
continuously calculating modulus values by calculating a modulus of a difference between percentages of usage of the computing resource for each pair of nodes in the multiple nodes;
sorting the modulus values in descending order; and
denominating nodes of each pair of nodes as N_{mhigh} and N_{nlow}, so that a consumption of the computing resource for N_{mhigh} is greater than a consumption of the computing resource for N_{nlow},
wherein the shuffling the one or more containers between the first and second nodes includes shuffling containers of N_{mhigh} and N_{nlow}, so that a modulus of a difference between a first percentage of the computing resource being consumed by N_{mhigh} and a second percentage of the computing resource being consumed by N_{nlow} is less than the specified threshold amount.

14. The computer program product of claim 8, wherein the computing resource being utilized includes a memory, a central processing unit, a disk, or a computer network resource.

15. A computer-implemented method comprising:
scheduling, by one or more processors, containers on multiple nodes of a cluster so that percentages of a computing resource being utilized on the multiple nodes are modified to match each other within a specified threshold amount, wherein the scheduling includes:
determining, by the one or more processors, differences of percentages of the computing resource being used between nodes included in pairs of nodes included in the multiple nodes;
determining, by the one or more processors, that a difference of percentages of the computing resource being used between a first node and a second node exceeds the specified threshold amount, the first and second nodes are included in a given pair of nodes included in the pairs of nodes; and
shuffling, by the one or more processors, one or more containers between the first and second nodes so that a difference of percentages of the computing resource being used between the first and second nodes does not exceed the specified threshold amount.

16. The method of claim 15, further comprising:
repeating, by the one or more processors, the shuffling for one or more containers between other first and second nodes in any other of the pairs of nodes in which a difference of percentages of the computing resource being used between the other first and second nodes exceeds the specified threshold amount, wherein the repeating provides a scheduling of the containers so that respective percentages of the computing resource consumed on the multiple nodes are within the specified threshold amount.

17. The method of claim 15, further comprising:
determining, by the one or more processors, that the first node in the given pair of nodes has greater consumption of the computing resource than the second node in the given pair of nodes;
based on the first node in the given pair of nodes having the greater consumption of the computing resource than the second node in the given pair of nodes, identifying, by the one or more processors, containers on the first node in the given pair of nodes, determining, by the one or more processors, respective usages of the computing resource for the identified containers, and generating, by the one or more processors, an ordered list of the identified containers with the identified containers being ordered according to the respective usages;
determining, by the one or more processors, a first actual amount of the computing resource consumed by the first node in the given pair of nodes;
determining, by the one or more processors, a second actual amount of the computing resource consumed by the second node in the given pair of nodes;
calculating, by the one or more processors, an actual computing resource difference as a difference between the first and second actual amounts of the computing resource consumed on the first and second nodes, respectively, in the given pair of nodes;
performing, by the one or more processors, an iteration over the ordered list for the given pair of nodes and for a given identified container in the iteration,
determining, by the one or more processors, that a usage of the computing resource for the given identified containers is less than the actual computing resource difference; and
based on the usage of the computing resource for the given identified container being less than the actual computing resource difference, moving, by the one or more processors, the given identified container from the first node in the given pair of nodes to the second node in the given pair of nodes; and
recalculating, by the one or more processors, the actual computing resource difference based on the first and second actual amounts of the computing resource consumed on the first and second nodes, respectively, being updated as a result of the moving the given identified container from the first node to the second node.

18. The method of claim 17, wherein the recalculated actual computing resource difference does not exceed the specified threshold amount subsequent to the iteration.

19. The method of claim 15, further comprising:
obtaining, by the one or more processors, historical information about usage of the computing resource by the containers; and
initially deploying, by the one or more processors, the containers on empty nodes based on the historical information, with a usage of the computing resource for a container on a node being initially assigned a value from the historical information.

20. The method of claim 15, further comprising:
continuously calculating, by the one or more processors, modulus values by calculating a modulus of a difference between percentages of usage of the computing resource for each pair of nodes in the multiple nodes;
sorting, by the one or more processors, the modulus values in descending order; and
denominating, by the one or more processors, nodes of each pair of nodes as N_{mhigh} and N_{nlow}, so that a consumption of the computing resource for N_{mhigh} is greater than a consumption of the computing resource for N_{nlow},
wherein the shuffling the one or more containers between the first and second nodes includes shuffling containers of N_{mhigh} and N_{nlow}, so that a modulus of a difference between a first percentage of the computing resource being consumed by N_{mhigh} and a second percentage of the computing resource being consumed by N_{nlow} is less than the specified threshold amount.
